(19) United States
(12) Patent Application Publication
(10) Pub. No.: US 2005/0265325 A1
(43) Pub. Date: Dec. 1, 2005

(54) Voice conference with scalability and low bandwidth over a network

(75) Inventor: Mingtar Tsai, Cupertino, CA (US)

Correspondence Address: Mingtar Tsai, 19925 Stevens Creek Blvd., Cupertino, CA, 95014, US

(73) Assignee: Mingtar Tsai

(21) Appl. No.: 11/033,856

(22) Filed: Jan. 12, 2005

Related U.S. Application Data
(60) Provisional application No. 60/571,589, filed on May 17, 2004.

(51) Int. Cl. H04L 12/66

(52) U.S. Cl. 370/356

(57) ABSTRACT

A system and method to allow voice conference to pass through Internet/Intranet, which include network address translator (NAT). The system also includes an Internet Phone device, a regular PSTN phone, a VoIP gateway and a conference server. The server sends command and data either using transmission control protocol (TCP) or user datagram protocol (UDP), depending on the configuration and protocol requirements of each server. This method is compatible with existing communication standards, such as ITU H.323, session initiation protocol (SIP), media gateway control protocol (MGCP) and media gateway control (MEGACO).

### BACKGROUND OF THE INVENTION

1. Field of the Invention

This invention relates to a transmission method for voice data communications over a network. More particularly, the present invention relates to a transmission method and system to enable voice data communication through corporate Intranets or the Internet.

2. Related Art of the Invention

Voice/video over Internet Protocol (VoIP) is a vital application over the Internet and corporate intranets. Most of the major telecommunication carriers are ready for the mass deployment of VoIP services. Voice conference is one of the major applications for VoIP. Traditionally, callers use analog/digital phone to make call through PSTN conference bridge for conferencing. This type of traditional voice conference can not handle calls originating from the Internet that conform to standard VoIP protocol such as H323, and SIP.

### SUMMARY OF THE INVENTION

The present invention is to provide a method and system enabling voice conference via conference servers, which allows communication between callers.

The present invention supports callers originating from regular PSTN or the Internet using VoIP.

The present invention supports one caller calling through Internet Phone and the other caller through PSTN.

The present invention supports Internet VoIP caller using transmission control protocol (TCP) or user datagram protocol (UDP) for transmitting command and voice data.

The present invention supports voice communication between callers ultilizing any of the existing communication protocols, such as H.323 (a standard approved by the International Telecommunication Union, reference ITU-T H.323), session initiation protocol (SIP, reference IETF RFC 2543), media gateway control protocol (MGCP, reference IETF RFC 2705), and media gateway control (MEGACO, reference ITU-T H.248).

The present invention supports voice conference through conference server that performs digital mixing of voice data.

The present invention supports voice over IP gateway that accepts regular call through PSTN.

The present invention supports voice data, after digitally mixed by conference server, sent to VoIP gateway and Internet Phone.

### BRIEF DESCRIPTION OF THE DRAWINGS

These, as well as other features of the present invention, will become apparent upon reference to the drawings wherein:

FIG. 1 is a block diagram depicting conference server which includes signal server and media server.

FIG. 2 is a block diagram depicting one method of the VoIP data transmission through network according to a preferred embodiment of the present invention.

FIG. 3 is a block diagram depicting one method of the VoIP data transmission through PSTN according to a preferred embodiment of the present invention

FIG. 4 is a printout displaying the format of real-time transport protocol (RTP) with header extensions according to the present invention.

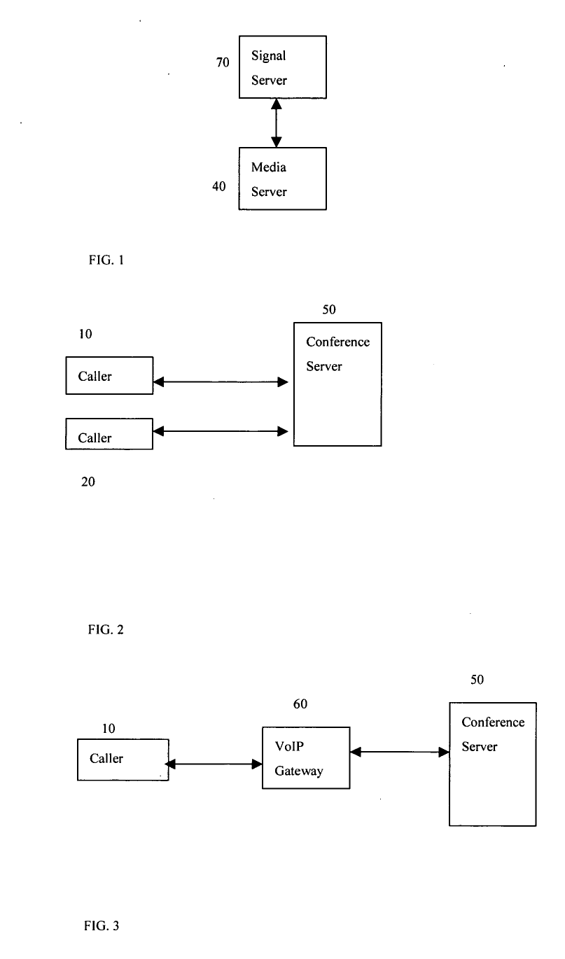

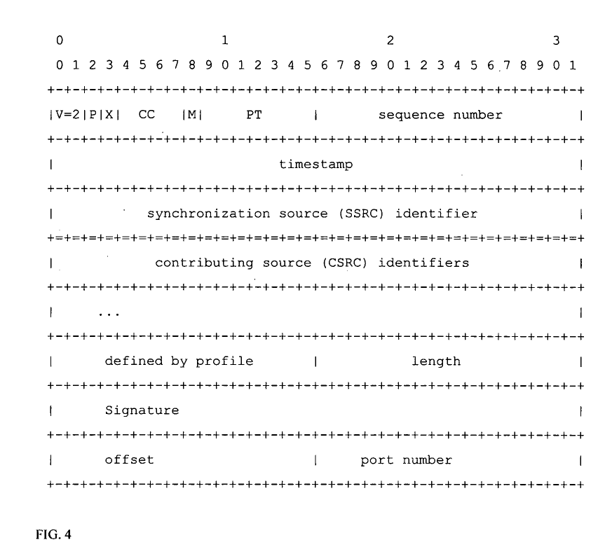

### DESCRIPTION OF THE PREFERRED EMBODIMENTS

Callers 10 and 20 go to the web conference login page by using a browser, such as Microsoft Internet Explore (IE). Caller 10 chooses the intended conference session and login the conference session. After callers 10 and 20 login, the web server will download Internet Phone software (softphone) to callers 10 and 20s' PC and connect callers 10 and 20 to the conference server 50 with a unique identification (ID) for each caller and the session number.

While making the connection, commands are sent from callers 10 and 20 to the conference server 50. The conference server 50 saves relevant information of each caller, e.g. session number and ID. The conference server 50 then sends the “acknowledge” commands to caller 10 using a protocol supported by caller 10, for example, UDP or TCP. Conference server 50 can be one of the many standard conforming servers such as H.323 Gatekeeper (a standard approved by the International Telecommunication Union, reference ITU-T H.323, which can be easily obtained in the internet, for example, the website http://www.itu.int), session initiation protocol Proxy server (SIP, reference IETF RFC 2543, which can be easily obtained in the internet, for example, the website link http://www.ietf.org), media gateway control protocol callagent server (MGCP, reference IETF RFC 2705, which can be easily obtained in the internet, for example, the website link http://www.ietf.org), and media gateway control callagent server (MEGACO, reference ITU-T H.248, which can be easily obtained in the internet, for example, the website link http://www.ietf.org). A response is then sent back to callers 10 and 20 by the conference server 50.

The conference server 50 saves the caller's unique ID, session number, IP address and the user datagram protocol (UDP) port number of the endpoint in order to communicate with callers. This allows the media server 40 to know which caller the data is coming from.

Caller can join a conference by calling from regular PSTN analog/digital phone. The call will go through PSTN and connect to a VoIP compliant telephony gateway 60. A gateway is a device that translates VoIP signals into signals that can be understood by traditional phone system and vise versa. Each caller will be instructed to enter the conference number and assigned a unique ID.

VoIP gateway 60 will send voice command and data to conference server 50.

Conference server 50 can select one of two methods to mix voice data from callers. One method is the traditional way, by mixing all of the voice data and send the mixed voice data to each caller. The other method is to put all of the voice data together and send to each caller for mixing.

To make conference server 50 highly scalable and low CPU consumption, the conference server 50 will detect if each caller is capable of mixing voice data. If the caller calls from a regular phone, it does not have the capability to mix voice data. If the caller calls from an Internet Phone device with the capability to mix voice data, then conference server 50 will mark this caller with a flag as being a special device.

If all of the callers are capable of mixing voice data, conference server 50 will put all of the voice data together and send the combined data to each caller device for mixing. Voice data is encapsulatd in RTP. Each caller voice data has its own RTP header. In this case, conference server 50 can handle large number of users in the hundreds and thousands depending on available computer resources, such as CPU power, memory speed and size, and network speed.

The Internet Phone device can be hardware device or software only. The Internet Phone device must have enough CPU power to perform voice compression and decompression. To reduce Internet bandwidth consumption, voice codec, such as g.723.1, g.729, or any low bit rate codec can be used. Voice silence detection (VAD) can also be utilized to reduce the amount of voice data transmission. Internet phone device can be configured to send voice packet every 10˜100 ms. Each packet sent to conference server 50 can have one frame or multiple frames of voice data. Voice data is encapsulated in the RTP format. A unique user ID is also encapsulated in the RTP data.

After conference server 50 receives RTP data from callers, it will check the number of callers in the same conference session. If the session has only two callers, conference server 50 will send RTP data from one caller to the other caller without mixing the voice data. If the session has more than 2 callers, conference server 50 will determine if all of the callers are capable of mixing voice data. If they are capable of mixing voice data, conference server 50 will put all of the arriving RTP data together excluding the one from the sending caller and send the combined RTP data to all callers. If one caller, such as regular phone device, can not mix voice data, the conference server 50 will decompress all of the arriving voice data to 16-bit mono PCM data first. After decompression is completed, conference server 50 then mixes the voice data, and compresses the mixed voice data using user-defined codec. After the mixed voice data is compressed, conference server will encapsulate the data into RTP format and send the RTP data to the right caller.

When Internet Phone device receives RTP data, it will check if the voice data needs mixing or not. If the voice data does not require mixing, the Internet Phone device will retrieve voice data from the RTP packet, decompress the data if necessary and then send the final data to the sound device for playback. If the voice data requires mixing, the Internet Phone device will retrieve every voice data and its corresponding user ID in the RTP packet first and then decompresses and saves each voice data to memory. Every user ID has its own memory buffer for storing the voice data. After decompression, the Internet Phone device will mix all of the voice data and send the mixed data to the sound device for playback.

When VoIP gateway 60 receives RTP data from conference server 50. It retrieves voice data from RTP packet and decompresses to a format that regular phone device can play, such as Mu-Law in US. After decompression, gateway 60 sends the voice data through PSTN to the caller's phone device.

In this embodiment the endpoints, 10 and 20, send commands and voice data using TCP or UDP. The command sent by the original endpoint includes voice data and the private or public IP address, port number, and identification of the destination endpoint.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A transmission method for voice data through a network, the method comprising:
a first Internet Phone endpoint sending a first command to a conference server with a first data transmission protocol, wherein the conference server obtains information of the first caller and saves the information therein;
the conference server sending the first response to the first caller, thereby the transmission for voice data through the first caller and the server is established there.

2. The transmission method of voice data according to claim 1, wherein server includes a signal server.

3. The transmission method of voice data according to claim 1, wherein the conference server includes a media server.

4. The transmission method of voice data according to claim 1, wherein the Internet Phone endpoint includes software running on the computer.

5. The transmission method of voice data according to claim 1, wherein the Internet Phone endpoint includes a hardware device.

6. The transmission method of multimedia data according to claim 2, wherein the signal server is a H.323 Gatekeeper.

7. The transmission method of multimedia data according to claim 2, wherein the signal server is a session initiation protocol (SIP) Proxy server.

8. The transmission method of multimedia data according to claim 2, wherein the signal server is a media gateway control protocol (MGCP) callagent server.

9. The transmission method of multimedia data according to claim 2, wherein the signal server is media gateway control (MEGACO) callagent server.

10. The transmission method of voice data according to claim 3, wherein the conference server is a voice over Internet protocol (VoIP) compliant.

11. The transmission method of voice data according to claim 3, wherein a real-time transport protocol (RTP) is being supported in the communication between the endpoint and the media server.

12. The transmission method of voice data according to claim 3, wherein the voice data transferred between the first endpoint and the signal server, and the media server transmission protocol is user datagram protocol (UDP).

13. A transmission method for voice data through a network, the method comprising:
a second endpoint caller using regular phone to VoIP gateway. VoIP gateway sending a second command to a conference server with a second data transmission protocol, wherein the conference server obtains information of the second endpoint and saves the information therein;
the conference server sending the second response to the VoIP gateway. VoIP gateway sends response to endpoint, thereby the transmission for voice data through the second endpoint and the server is established there.

14. The transmission method of voice data according to claim 12, wherein the second endpoint includes a regular phone.

15. The transmission method of voice data according to claim 12, wherein the second endpoint includes a VoIP gateway.

16. A system for transmitting voice data between a Internet Phone device, and a conference server, the system comprising:
a first transmission path, for the Internet Phone device to send a first command to the conference server with a first data transmission protocol, wherein the conference server obtains information of the first Internet Phone device and saves the information therein;
a conference server sends un-mixed data to Internet Phone device. Internet Phone device receives the data, decompresses, mixes and plays the voice data through sound device.

17. The system of claim 16, wherein the Internet Phone device is a hardware device.

18. The system of claim 16, wherein the Internet Phone device is a software program.

19. The system of claim 16, wherein the Internet Phone device support voice codec—g.723.1, g.729a, GSM, etc.

20. The system of claim 16, wherein the Internet Phone device support multiple RTP stream and multiple frames.

21. A system for transmitting voice data between a Internet Phone device, a regular phone and a conference server, the system comprising:
a second transmission path, the regular phonecalls into the VoIP gateway and VoIP gateway sends a second command to the conference server with a second data transmission protocol, wherein the conference server obtains information of the second VoIP gateway and saves the information. Conference server sends response to the VoIP gateway. The VoIP gateway sends the response to the phone device through PSTN.
a conference server decompress, mixes, and compresses the voice data and encapsulates the final data in RTP stream. Conference server sends RTP stream to Internet Phone device and VoIP gateway, VoIP gateway sends voice data to regular phone.

22. The system of claim 21, wherein the conference server support, but not limited to, voice codec such as g.723.1, g.729a, GSM.

23. The system of claim 21, wherein the conference server supports high-bit rate non-compressed voice data—Mu-Law and A-Law.
